(19) United States
(12) Patent Application Publication
(10) Pub. No.: US 2022/0087465 A1
(43) Pub. Date: Mar. 24, 2022

(54) Receiving Enclosure

(71) Applicant: e-Delivery Locker Pty Ltd, Brisbane (AU)

(72) Inventor: Seth Peady, Brisbane (AU)

(21) Appl. No.: 17/377,563

(22) PCT Filed: Dec. 12, 2019
(86) PCT No.: PCT/AU2019/051366

§ 371 Date: Jul. 16, 2021

(30) Foreign Application Priority Data
Dec. 12, 2018 (AU) 2018904723

(51) Int. Cl. A47G 29/14; E05B 49/00; F25D 13/04; G07C 9/00

(52) U.S. Cl. CPC A47G 29/141; E05B 49/00; F25D 13/04; E05B 39/00; A47G 2029/147; A47G 2029/145; G07C 9/00912

(57) ABSTRACT

A receiving enclosure for receiving goods, the receiving enclosure having one or more doors movable between an open position and a closed position, and a locking device adapted to releasably secure the one or more doors in the closed position.

### CROSS-REFERENCE TO RELATED APPLICATIONS

This application is the United States national phase of International Application No. PCT/AU2019/051366 filed Dec. 12, 2019, and claims priority to Australian Patent Application No. 2018904723 filed Dec. 12, 2018, the disclosures of which are hereby incorporated by reference in their entirety.

### BACKGROUND OF THE INVENTION

### Field of Invention

The present invention relates to a receiving enclosure. Reference will be made in the specification to the use of a receiving enclosure having one or more insert modules related to refrigerating, freezing, warming and/or heating of received deliveries of foodstuffs and/or perishable goods. The patent specification describes this use, but it is by way of example only and the invention is not limited to this use.

### Description of Related Art

With an increase in online shopping, there is an increase in deliveries of goods bought online. A problem with larger deliveries is that they cannot be left in mailboxes.

Presently, larger deliveries are sometimes left unattended at a premise, either in front of a front door, or at another location such as a front porch.

Deliveries can also be re-routed to an alternate address such as a work address or kept at a post office for a later pick up. Alternatively, deliveries can be scheduled for a later time when somebody is present to accept the delivery.

A problem with current deliveries is that unattended deliveries can be subject to theft or damage from the environment.

Another problem is that deliveries that are re-routed or scheduled for a later time may not be received in a timely manner. For example, postal deliveries that cannot be safely left at a premise are sometimes taken to a post office and are available for pick up a day after the initial attempted delivery.

A further problem with scheduling deliveries for a later time is that delivery organisations will typically have a small window of time in which goods can be delivered.

One prior art solution includes providing the delivery organisation with access to the premises. However, many people are not comfortable with allowing access to their premises when they are not present.

A problem with food deliveries and perishable goods is that they can spoil if left unattended for too long. One solution to this is to schedule food deliveries during times when somebody is present to accept the delivery.

### OBJECT OF THE INVENTION

It is an object of the present invention to overcome or at least alleviate one or more of the abovementioned problems with delivery of goods and/or provide the consumer with a useful or commercial choice.

### SUMMARY OF THE INVENTION

In one aspect, the present invention broadly resides in a receiving enclosure for receiving goods, the receiving enclosure having

one or more doors movable between an open position and a closed position; and

a locking device adapted to releasably secure the one or more doors in the closed position.

Preferably the receiving enclosure further includes at least one temperature-controlled compartment.

In another aspect, the present invention broadly resides in a receiving enclosure for receiving goods, the receiving enclosure having

one or more doors movable between an open position and a closed position;

a locking device adapted to releasably secure the one or more doors in the closed position; and

at least one temperature-controlled compartment located within the enclosure.

Preferably, the locking device is an electronic locking device. More preferably the electronic locking device is a smart lock. Preferably, the locking device includes a locking mechanism which is adapted to releasably secure the one or more doors in the closed position. Preferably, the locking device can be remotely actuated. Preferably when actuated, the locking device releases the one or more doors so that the one or more doors can move to the open position.

Preferably the locking device can remotely communicate with a mobile device. Preferably the locking device is actuated when it receives a security code or authorisation code from the mobile device.

Preferably the locking device is able to communicate wirelessly with the mobile device. Preferably the receiving enclosure includes a communication module.

Preferably the communications module includes a Wi-Fi, Bluetooth and/or Near-field communication (NFC) modem. Preferably the communication module enables the locking device to communicate with the mobile device. In one embodiment, the locking device communicates with the mobile device using Wi-Fi. In another embodiment, the locking device communicates with the mobile device using Bluetooth. In a further embodiment, the locking device communicates with the mobile device using NFC. In another embodiment, the locking device is connected to the internet and the mobile device communicates with the locking device via the internet. In one embodiment, the mobile device is a computer connected to the internet.

In one embodiment, the mobile device can set a code to open the locking device. Preferably a delivery person can enter the code into the locking device to actuate the locking device. Preferably the locking device includes a keypad. Preferably a delivery person can enter the code into the locking device using the keypad. Preferably the code is a one-time code. Preferably, a delivery person can communicate the code to the locking device using a mobile device to actuate the locking device.

Preferably the receiving enclosure includes a cover adapted to cover the locking device or part thereof.

In one embodiment, the receiving enclosure is adapted to communicate with an e-commerce server on the internet, such that when a good is purchased from the e-commerce server, a code to open the locking device is set, this code is communicated to the delivery organisation which is used to deliver the good, such that a delivery person can communicate the code to the locking device to actuate the locking device.

Preferably each of the one or more doors includes insulation. Preferably the locking device is attached to at least one of the one or more doors. Preferably the locking device is adapted to engage with a side of the receiving enclosure. In one embodiment, each of the one or more doors has a locking device.

In one embodiment, the one or more doors is two doors. Preferably a first of the two doors partially overlaps a second of the two doors. Preferably, when both doors are in the closed position, securing the first door also secures the second door.

Preferably the receiving enclosure includes one or more sensors to determine if the one or more doors are in the closed position. Preferably the locking device is adapted to not lock unless all of the one or more doors are in the closed position.

Preferably the receiving enclosure includes side panels. Preferably the receiving enclosure includes a rear panel. Preferably the panels provide insulation.

In one embodiment, the receiving enclosure includes an access door. Preferably the access door is located on a different side of the receiving enclosure than the one or more doors. Preferably the access door is fitted into the rear panel.

Preferably the receiving enclosure includes a top panel. Preferably the top panel is adapted to drain rain from the top of the receiving enclosure. Preferably the receiving enclosure includes a bottom panel. Preferably the top panel and the bottom panel provide insulation.

Preferably the receiving enclosure is adapted to attach to a portion of a building, fence and/or the ground below the receiving enclosure to provide in-situ security. In one embodiment, the receiving enclosure includes a bottom adaptor plate to secure the receiving enclosure to the ground below the receiving enclosure. Preferably the bottom adaptor plate is adapted to level the receiving enclosure relative to a ground surface.

Preferably the receiving enclosure is adapted to attach to an adjacent receiving enclosure. In one embodiment, the receiving enclosure includes a mid connector to attach the receiving enclosure to an adjacent receiving enclosure.

Preferably the receiving enclosure includes one or more shelves so that items can be stored on the shelves. Preferably the one or more shelves are adjustable.

Preferably the receiving enclosure includes one or more sensors to detect when a delivery has been made. Preferably the one or more sensors include one or more of a weight sensor, a sensor to detect the opening or closing of the door or locking device, an infra-red sensor or the like. Preferably the receiving enclosure is able to communicate with the mobile device when a delivery has been made.

Preferably the receiving enclosure includes one or more cameras. Preferably the one or more cameras are motion activated to record activity in and/or around the receiving enclosure. Preferably the recording from the one or more cameras can be transferred to the mobile device. In one embodiment, if the one or more cameras are activated, the recording from the one or more cameras are sent to the mobile device, the mobile device issues an alert and can be used to actuate the locking device to allow access to the receiving enclosure.

Preferably at least one of the at least one temperature-controlled compartment is a warming and/or heating compartment. Preferably at least one of the at least one temperature-controlled compartment is a cooling compartment. Preferably the cooling compartment is a refrigeration and/or freezer compartment. Preferably each of the at least one temperature-controlled compartment is modular and interchangeable.

Preferably the temperature and/or operation of each of the at least one temperature-controlled compartment can be controlled by the mobile device. Preferably the communication module is connected to each of the at least one temperature-controlled compartment.

Preferably the receiving enclosure is modular and adapted to connect to an adjacent receiving enclosure. Preferably the receiving enclosure is between 800 mm to 900 mm wide. Preferably the receiving enclosure is substantially 840 mm wide. Preferably the receiving enclosure is between 600 mm to 700 mm deep. Preferably the receiving enclosure is substantially 650 mm deep.

In one embodiment the receiving enclosure is between 1900 mm to 2300 mm high. Preferably the receiving enclosure is substantially 2140 mm high. In another embodiment, the receiving enclosure is between 920 mm to 1200 mm high. Preferably the receiving enclosure is substantially 1060 mm high.

Preferably the receiving enclosure is connectable to mains power. Preferably the receiving enclosure includes a battery to supply electrical power.

In one embodiment, at least one of the one or more doors includes a slot. Preferably the slot is designed to prevent access through the slot by a human hand. Preferably the slot is sized to receive envelopes and small parcels. Preferably the slot is similar in size to a mail box slot. Preferably a flap is located adjacent the slot on an external side of the at least one of the one or more doors. Preferably a flap is located adjacent the slot on an internal side of the at least one of the one or more doors. Preferably the external flap opens outwardly. Preferably the internal flap opens inwardly towards an internal space of the receiving enclosure.

In another aspect, the present invention broadly resides in a receiving enclosure for receiving goods, the receiving enclosure having

a cover movable between an open position and a closed position;

a locking device adapted to releasably secure the cover in the closed position; and

at least one temperature-controlled compartment located within the enclosure.

Preferably the cover is a door. In another embodiment, the cover is a lid. It will be appreciated that the features relating to a door or one or more doors in this specification can also relate to the cover.

In one embodiment, the cover includes a slot. Preferably the slot is designed to prevent access through the slot by a human hand. Preferably the slot is sized to receive envelopes and small parcels. Preferably the slot is similar in size to a mail box slot.

In a further aspect, the present invention broadly resides in a receiving enclosure for receiving goods, the receiving enclosure having

a cover movable between an open position and a closed position;

a locking device adapted to releasably secure the cover in the closed position;

at least one warming and/or heating compartment located within the enclosure; and

at least one refrigerating and/or freezing compartment located within the enclosure.

In another aspect, the present invention broadly resides in a receiving enclosure for receiving goods, the receiving enclosure having

a door movable between an open position and a closed position;

a locking device adapted to releasably secure the door in the closed position; and

at least one temperature-controlled compartment located within the enclosure.

Preferably the at least one temperature-controlled compartment includes a warming and/or heating compartment.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a front section view of a receiving enclosure according to an embodiment of the present invention;

FIG. 2 is a side section view of the receiving enclosure of FIG. 1;

FIG. 3 is a front section view of the receiving enclosure of FIG. 1 with temperature-controlled compartments;

FIG. 4 is a side section view of the receiving enclosure of FIG. 3;

FIG. 5 is a front view of the receiving enclosure of FIG. 1;

FIG. 6 is a front view of a receiving enclosure according to another embodiment of the present invention;

FIG. 7 is a front section view of the receiving enclosure of FIG. 6;

FIG. 8 is a side section view of the receiving enclosure of FIG. 6;

FIG. 9 is a front section view of the receiving enclosure of FIG. 6 with a temperature-controlled compartment;

FIG. 10 is a is a side section view of the receiving enclosure of FIG. 6 with a temperature-controlled compartment;

FIG. 11 is a front section view of the receiving enclosure of FIG. 6 with temperature-controlled compartments;

FIG. 12 is a side view of the receiving enclosure of FIG. 11;

FIG. 13 is a front view of a refrigerator/freezer module;

FIG. 14 is a side section view of the refrigerator/freezer module of FIG. 13;

FIG. 15 is a perspective view of a refrigerator/freezer module;

FIG. 16 is a perspective view of the refrigerator/freezer module of FIG. 15 in an open position;

FIG. 17 is a front view of a warming/heating module;

FIG. 18 is a side section view of the warming/heating module of FIG. 17;

FIG. 19 is a perspective view of a warming/heating module;

FIG. 20 is a perspective view of the warming/heating module of FIG. 19; and

FIG. 21 is a perspective view of a refrigerator/freezer module;

FIG. 22 is a front section view of a receiving enclosure according to an embodiment of the present invention;

FIG. 23 is a side section view of the receiving enclosure of FIG. 22;

FIG. 24 is a schematic view of the receiving enclosure of FIG. 22 with temperature-controlled compartments;

FIG. 25 is a schematic side view of the receiving enclosure of FIG. 24

FIG. 26 is a front elevation of a receiving enclosure according to an embodiment of the present invention;

FIG. 27 is a side elevation of the receiving enclosure of FIG. 26;

FIG. 28A is a front elevation of a receiving enclosure according to an embodiment of the present invention;

FIG. 28B is a side elevation of the receiving enclosure of FIG. 28A;

FIG. 29A is a front section view of the receiving enclosure of FIG. 28A;

FIG. 29B is a side section view of the receiving enclosure of FIG. 28A;

FIG. 30A is a front elevation of receiving enclosure doors according to an embodiment of the present invention;

FIG. 30B is a side elevation of the receiving enclosure doors of FIG. 30A;

FIG. 31 is a front elevation of a receiving enclosure door according to an embodiment of the present invention;

FIG. 32 shows side elevations of a slot with flaps in a closed and open position;

FIG. 33 shows a front and side elevation of a receiving enclosure door according to an embodiment of the present invention;

FIG. 34 shows detailed vies of the locking device of FIG. 33.

### DESCRIPTION OF THE INVENTION

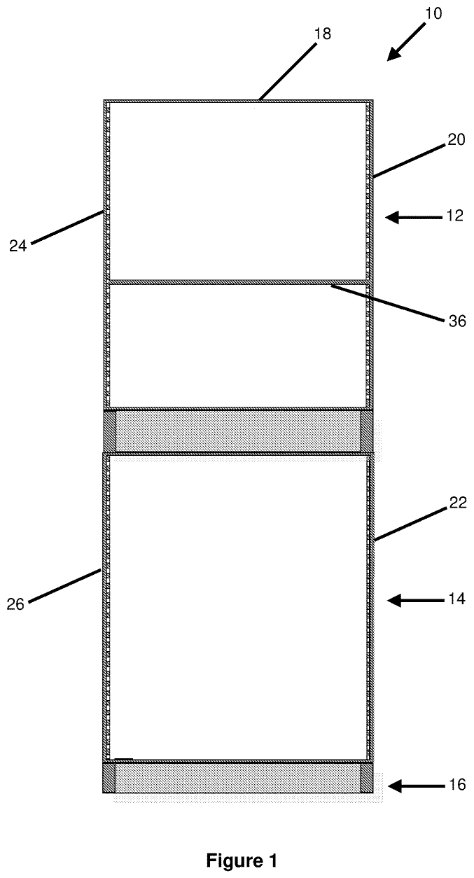

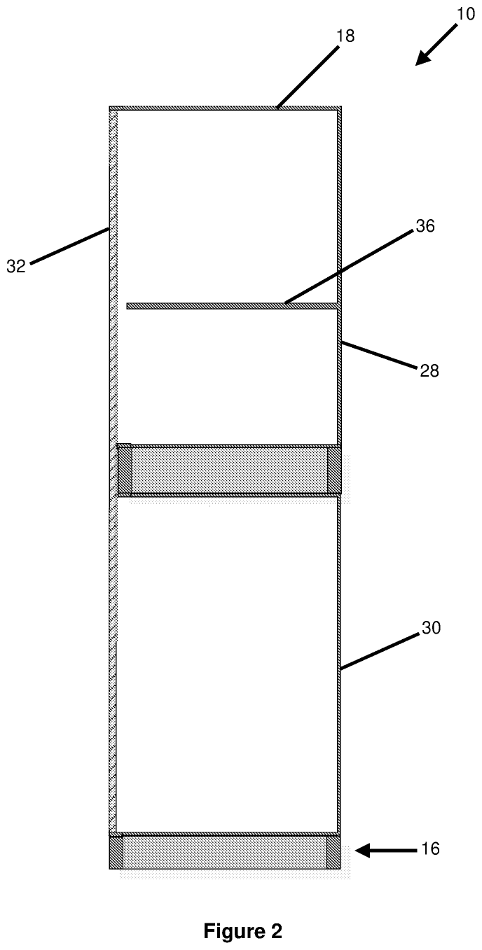

With reference to FIGS. 1 to 5, there is shown a receiving enclosure 10 according to an embodiment of the present invention. The receiving enclosure 10 has an upper section 12 and a lower section 14. The receiving enclosure 10 has a floor assembly 16 and a top panel 18. The floor assembly 16 includes a bottom panel (not shown) and a bottom adaptor plate (not shown). The receiving enclosure 10 has side panels 20,22,24,26, and rear panels 28,30. The material of the side panels 20,22,24,26, rear panels 28,30 bottom panel and the top panel 18 has insulation properties to insulate the receiving enclosure 10 from the elements.

The receiving enclosure 10 has a door 32 which is movable between a closed position (shown in FIG. 5) and an open position (not shown). The door 32 includes a locking device 34. The locking device 34 is a smart lock. The receiving enclosure 10 includes a communication module (not shown) which enables a mobile device (not shown) to communicate with the locking device 34 via Wi-Fi and actuate the locking device 34 to enable the door 32 to be moved from the closed position to the opened position.

The receiving enclosure 10 includes a shelf 36 to support larger packages.

The receiving enclosure 10 has a temperature-controlled compartment in the form of a warming/heating compartment 38. The warming/heating compartment 38 is adapted to receive food items or other items that need to be kept warm or hot. The warming/heating compartment 38 can be turned on and the temperature of the warming/heating compartment 38 can be adjusted by a mobile device (not shown) communicating with the warming/heating compartment 38 via the communication module (not shown). The receiving enclosure 10 has a temperature-controlled compartment in the form of a refrigeration compartment 40. The refrigeration compartment 40 is adapted to receive food items or other items that need to be kept cold. The refrigeration compartment 40 can be turned on and the temperature of the refrigeration compartment 40 can be adjusted by a mobile device (not shown) communicating with the refrigeration compartment 40 via the communication module (not shown). The receiving enclosure 10 has a temperature-controlled compartment in the form of a freezer compartment 42. The freezer compartment 42 is adapted to receive food items or other items that need to be kept frozen. The freezer compartment 42 can be turned on and the temperature of the freezer compartment 42 can be adjusted by a mobile device (not shown) communicating with the freezer compartment 42 via the communication module (not shown).

The receiving enclosure 10 can be secured to a building or similar structure (not shown) by a fixing strip or moulding around the side panels 20,22,24,26 and the top panel 18 to the building or structure. The receiving enclosure 10 can be secured to a building or similar structure (not shown) by bolting a bottom adaptor plate (not shown) of the floor assembly 16 to a floor of the building or structure.

The receiving enclosure 10 can be secured to an adjacent receiving enclosure (not shown).

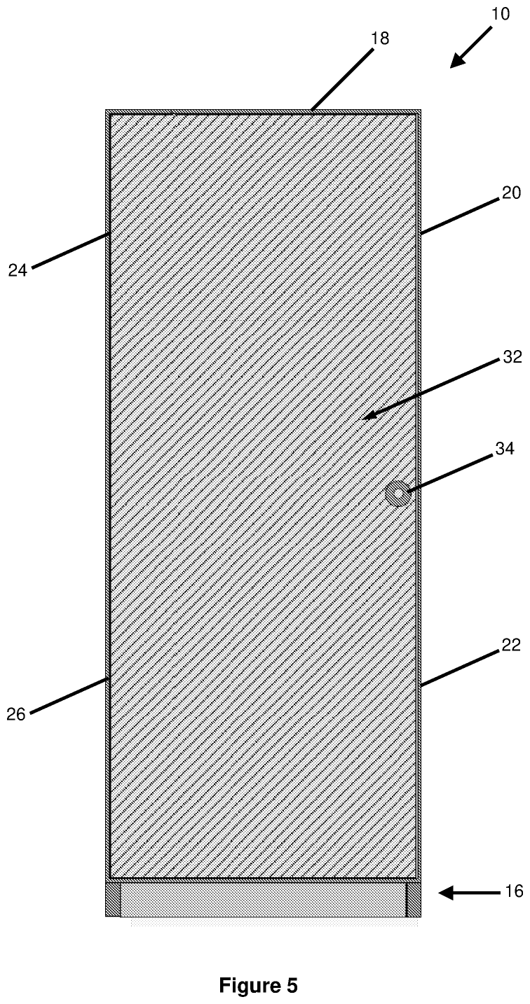

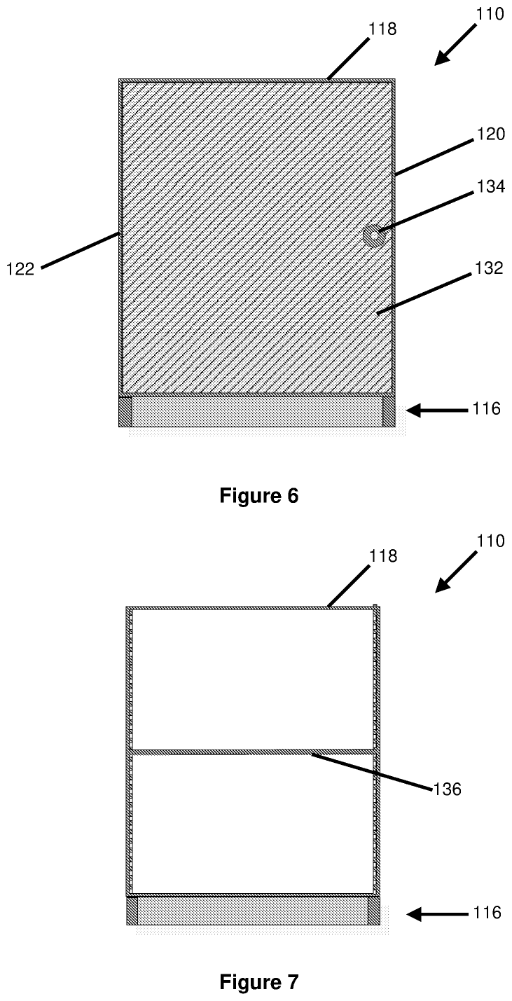

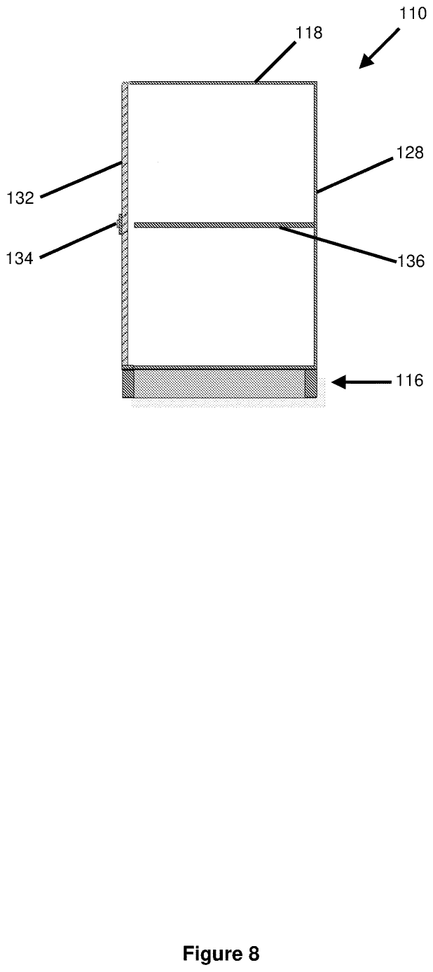

With reference to FIGS. 6 to 8, there is shown a receiving enclosure 110 according to another embodiment of the present invention.

The receiving enclosure 110 has a floor assembly 116 and a top panel 118. The floor assembly 116 includes a bottom panel (not shown) and a bottom adaptor plate (not shown). The receiving enclosure 110 has side panels 120,122 and a rear panel 128. The material of the side panels 120,122, rear panel 128, top panel 118 and floor assembly 116 have insulation properties to insulate the receiving enclosure 110 from the elements.

The receiving enclosure 110 has a door 132 which is movable between a closed position (shown in FIG. 6) and an open position (not shown). The door 132 includes a locking device 134. The locking device 134 is smart lock. The receiving enclosure 110 includes a communication module (not shown) which enables a mobile device (not shown) to communicate with the locking device 134 and actuate the locking device 134 to enable the door 132 to be moved from the closed position to the opened position.

The material of the door 132 has insulation properties to insulate the receiving enclosure 110 from the elements.

The receiving enclosure 110 includes a shelf 136 to support larger packages.

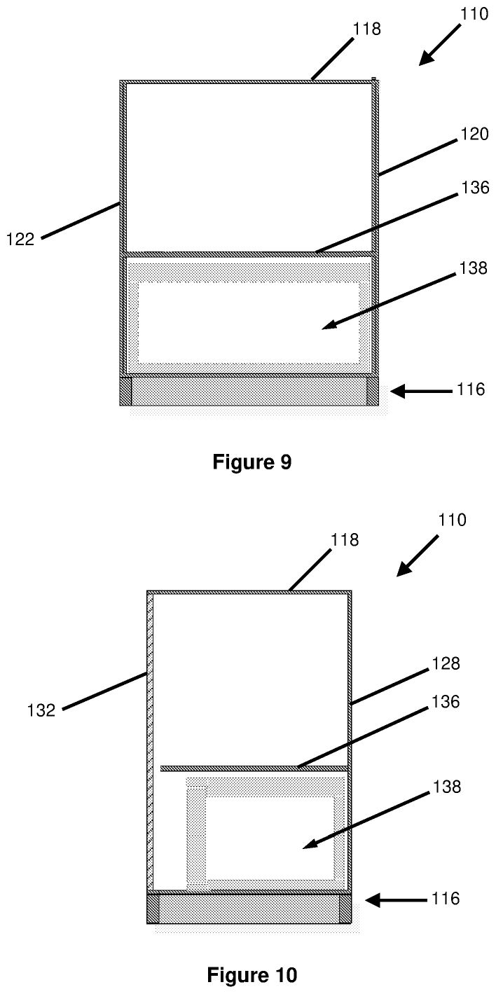

With reference to FIGS. 9 and 10, there is shown a receiving enclosure 110 of FIGS. 6 to 8 with a different internal configuration. In the configuration in FIGS. 9 and 10, the receiving enclosure 110 includes temperature-controlled compartments in the form of a warming/heating compartment 138.

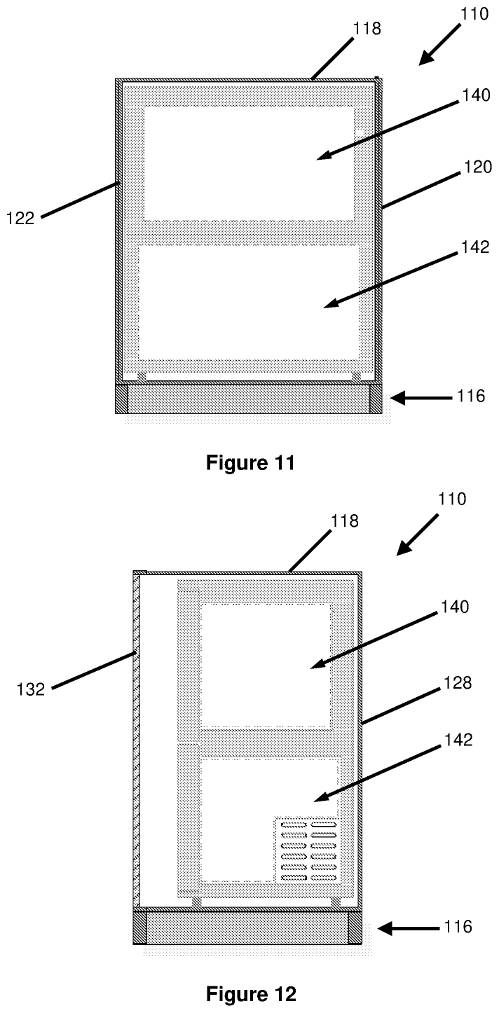

With reference to FIGS. 11 and 12, there is shown a receiving enclosure 110 of FIGS. 6 to 8 with a different internal configuration. In the configuration in FIGS. 11 and 12, the receiving enclosure 110 does not include a shelf or a heating compartment, instead, the receiving enclosure 110 includes temperature-controlled compartments in the form of a refrigeration compartment 140 and a freezer compartment 142.

Multiple receiving enclosures 110 of FIGS. 6 to 12 can be attached together depending on particular requirements. For example, the receiving enclosure 110 of FIGS. 9 and 10 can be attached to the receiving enclosure 110 of FIGS. 11 and 12. If multiple receiving enclosures 110 are connected together, the locking devices 134 can be kept separate so that only specific receiving enclosures can be opened by a delivery person.

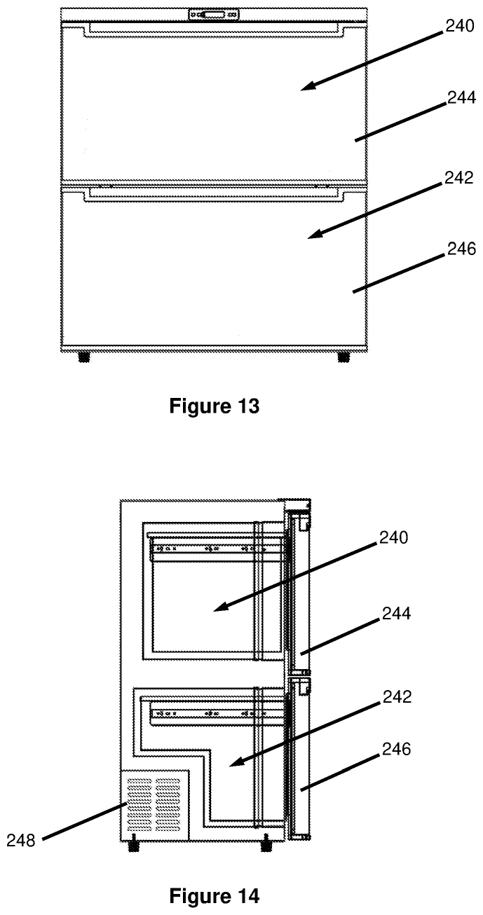

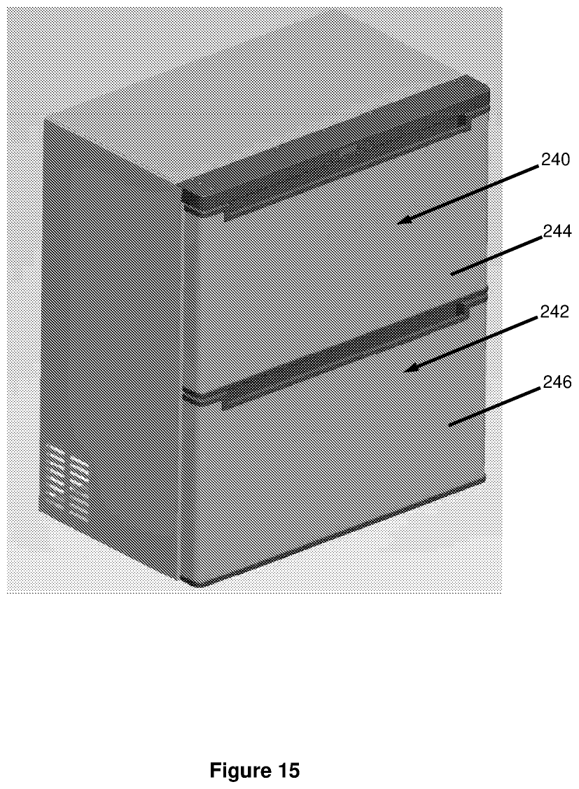

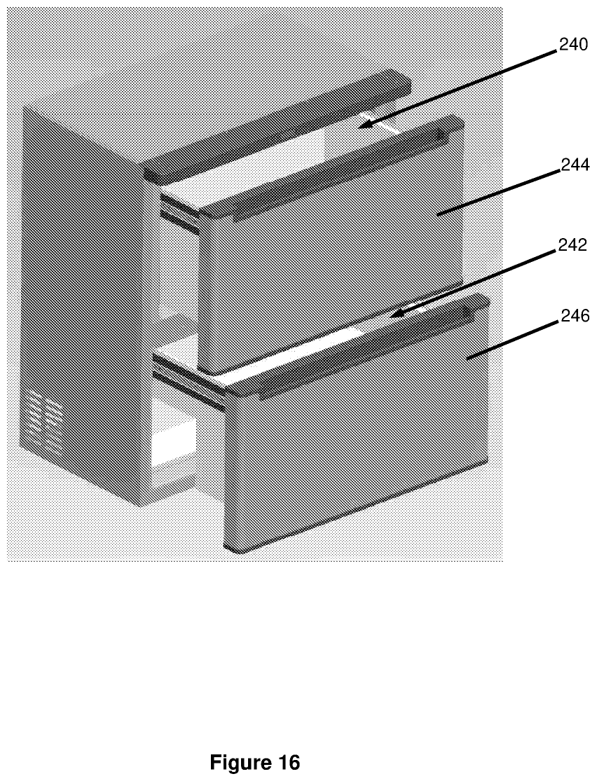

With reference to FIGS. 13 to 16, there is shown temperature-controlled compartments in the form of a refrigeration compartment 240 and a freezer compartment 242. The refrigeration compartment 240 includes a drawer 244 for easy access to the refrigeration compartment 240. The freezer compartment 242 includes a drawer 246 for easy access to the freezer compartment 242.

The refrigeration compartment 240 and the freezer compartment 242 are a single unit. The refrigeration compartment 240 and the freezer compartment 242 have a compressor 248 to regulate the temperature in the refrigeration compartment 240 and the freezer compartment 242 to desired temperatures. The refrigeration compartment 240 and the freezer compartment 242 communicate with the communication module (not shown), such that the temperature of the refrigeration compartment 240 and the freezer compartment 242 can be set by a mobile device (not shown).

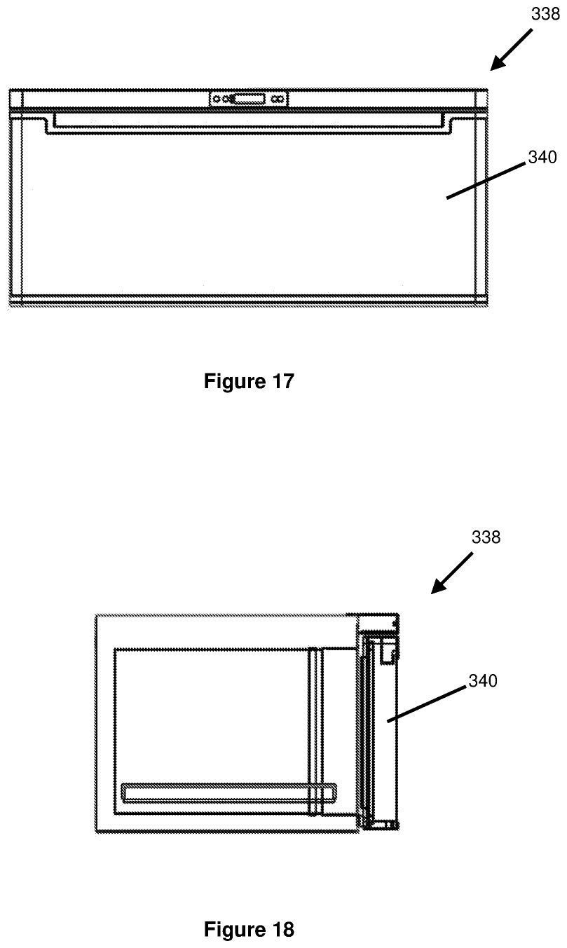

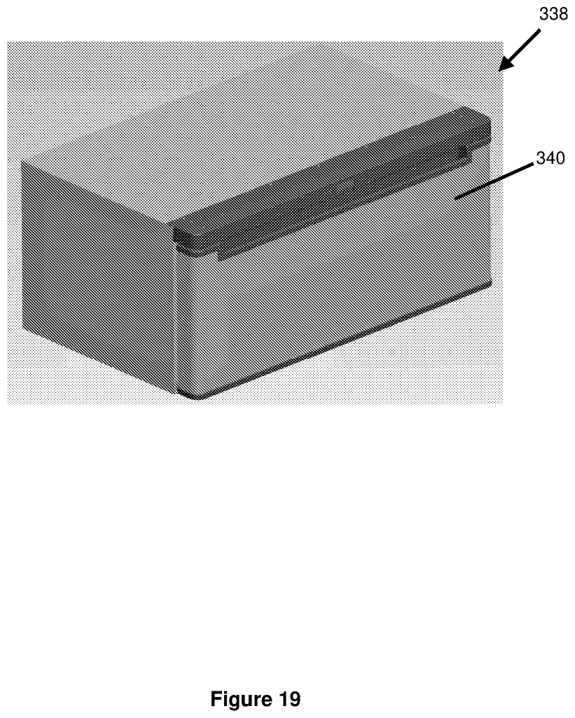

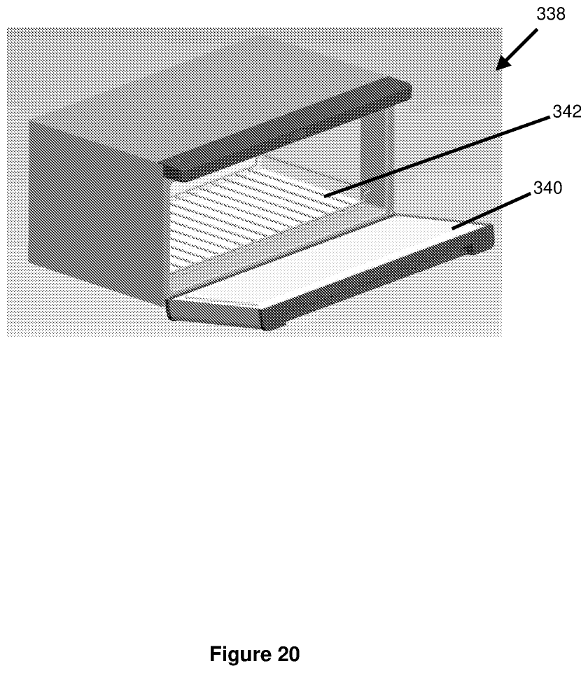

With reference to FIGS. 17 to 20, there is shown a temperature-controlled compartment in the form of a warming/heating compartment 338. The warming/heating compartment 338 includes a hinged door 340 for easy access to the warming/heating compartment 338. The warming/heating compartment 338 also includes a slide-out tray 342 for easy access to items (not shown) located in the warming/heating compartment 338.

The heating compartment 338 communicates with the communication module (not shown), such that the temperature of the heating compartment 338 can be set by a mobile device (not shown).

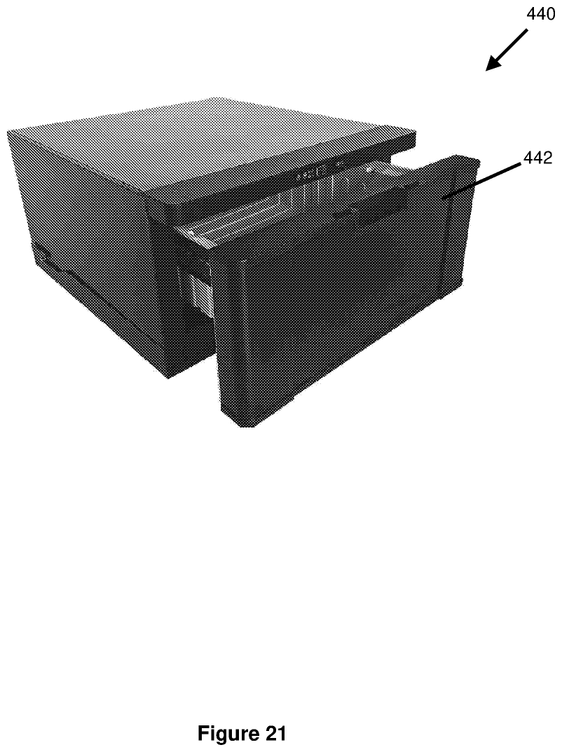

With reference to FIG. 21, there is shown a temperature-controlled compartment in the form of a refrigeration/freezer compartment 440. The refrigeration/freezer compartment 440 includes a drawer 442 for easy access to the refrigeration/freezer compartment 440.

The refrigeration/freezer compartment 440 communicates with the communication module (not shown), such that the temperature of the refrigeration/freezer compartment 440 can be set by a mobile device (not shown).

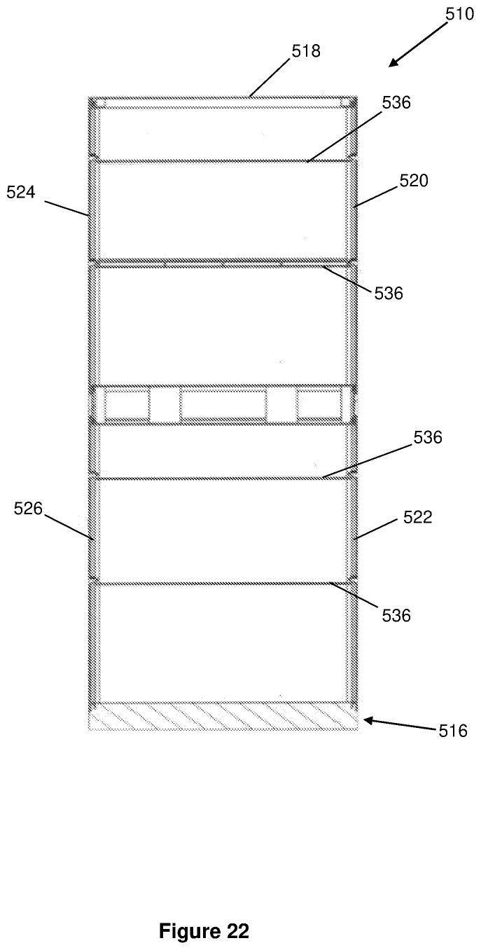

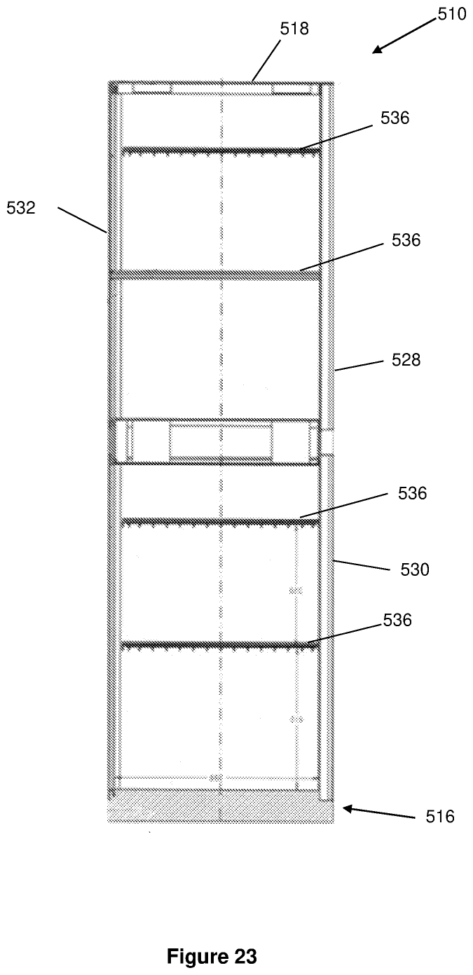

With reference to FIGS. 22 and 23, there is shown a receiving enclosure 510 according to an embodiment of the present invention. The receiving enclosure 510 is similar to the receiving enclosure 10 of FIG. 1, similar numbering has been used with the prefix of 5.

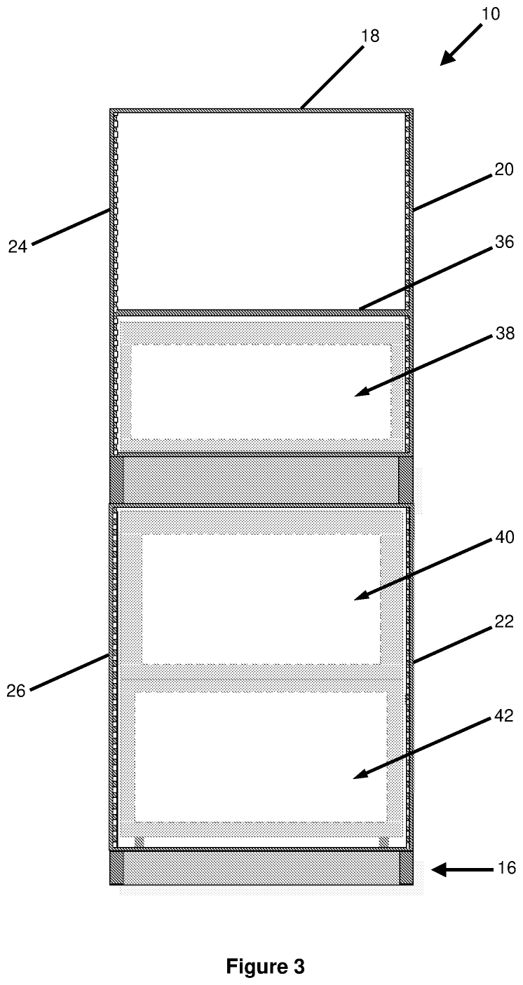

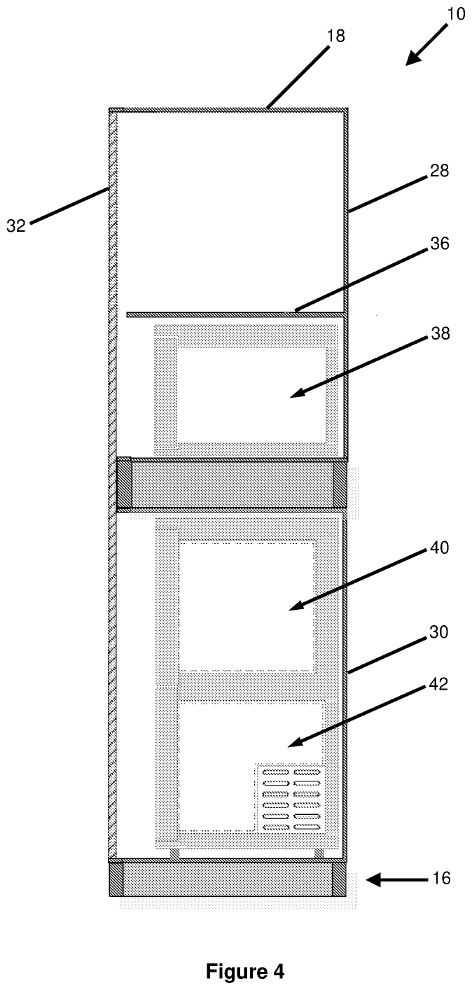

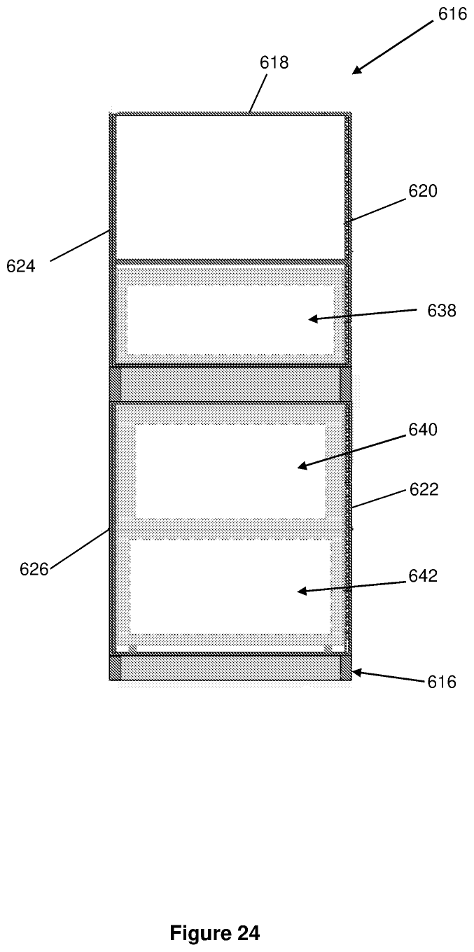

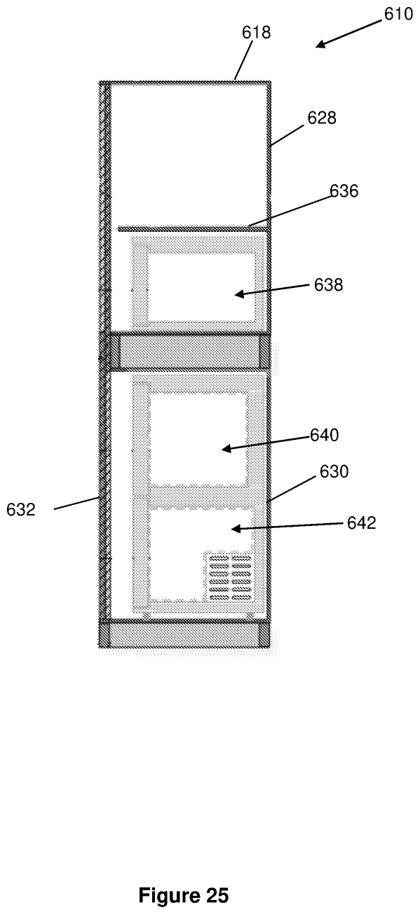

With reference to FIGS. 24 and 25, there is shown a receiving enclosure 610 according to an embodiment of the present invention. The receiving enclosure 610 is similar to the receiving enclosure 10 of FIGS. 3 and 4, similar numbering has been used with the prefix of 6.

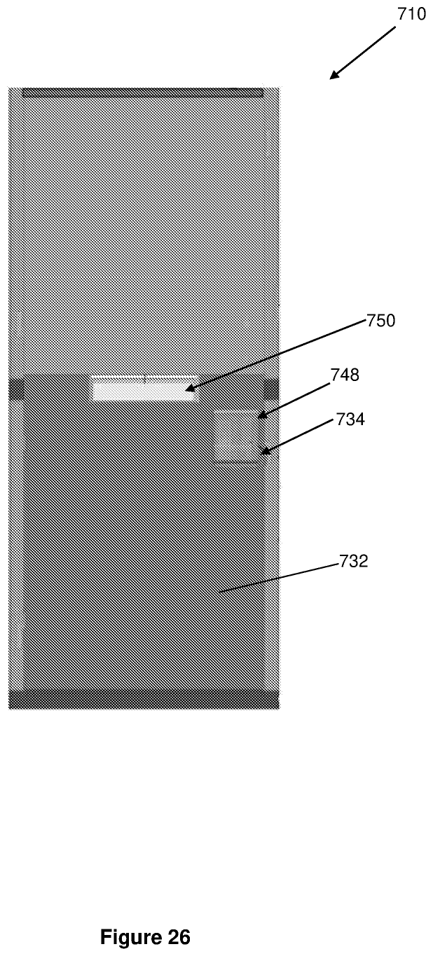

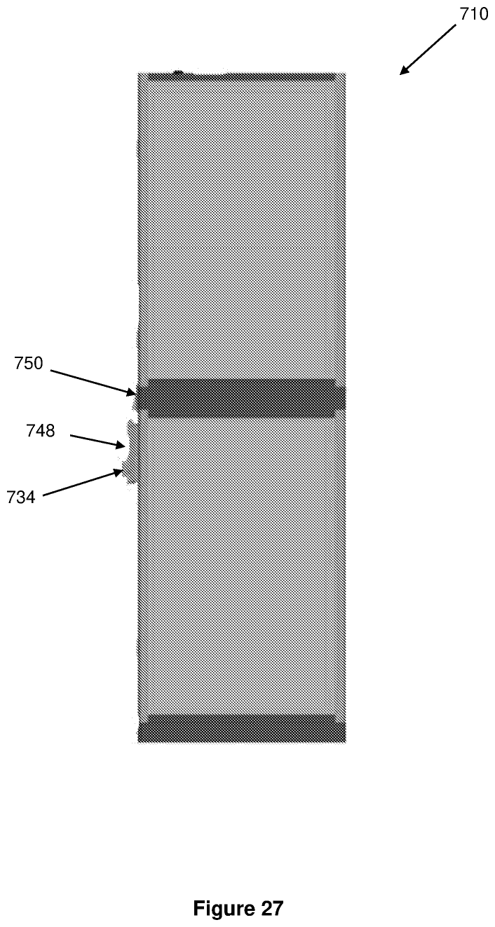

With reference to FIGS. 26 and 27, there is shown a receiving enclosure 710 according to an embodiment of the present invention. The receiving enclosure 710 has a door 732. The receiving enclosure 710 has a slot 750 located in the door 732. The receiving enclosure 710 has a locking device 734 and a transparent cover 748 to cover the locking device 734.

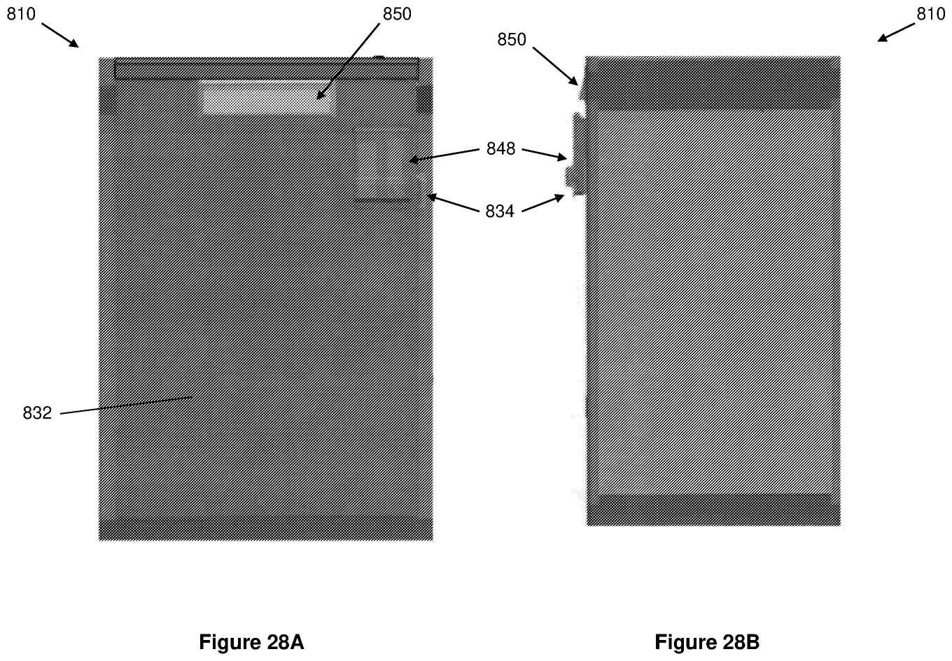

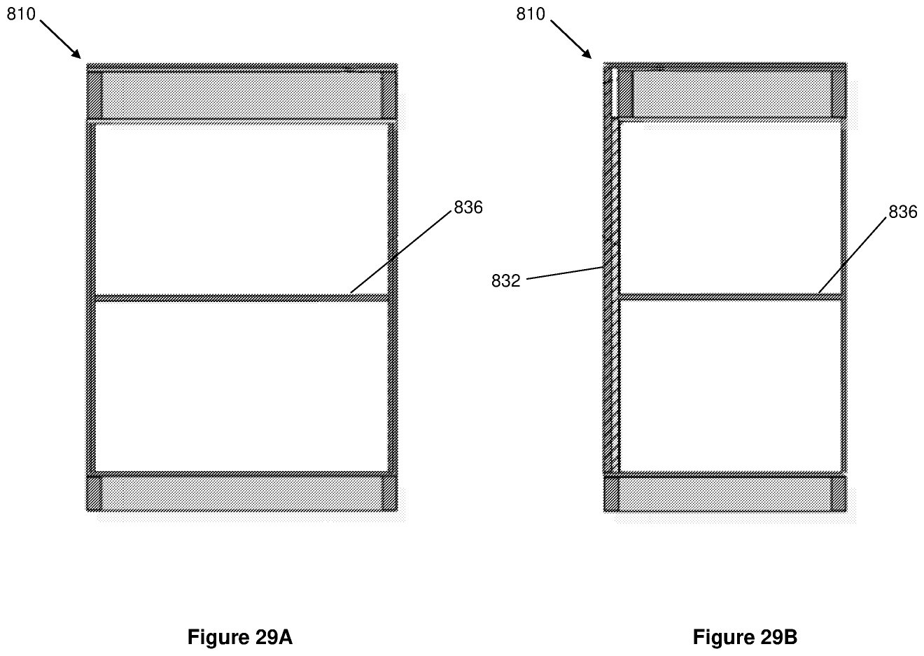

With reference to FIGS. 28A, 28B, 29A and 29B, there is shown a receiving enclosure 810 according to an embodiment of the present invention. The receiving enclosure 810 has a slot 850 for receiving small parcels and/or mail into a separate section of the receiving enclosure 810. The receiving enclosure 810 has a locking device 834 and a transparent cover 848 to cover the locking device 834. The receiving enclosure 810 has an adjustable shelf 836 to provide more storage space.

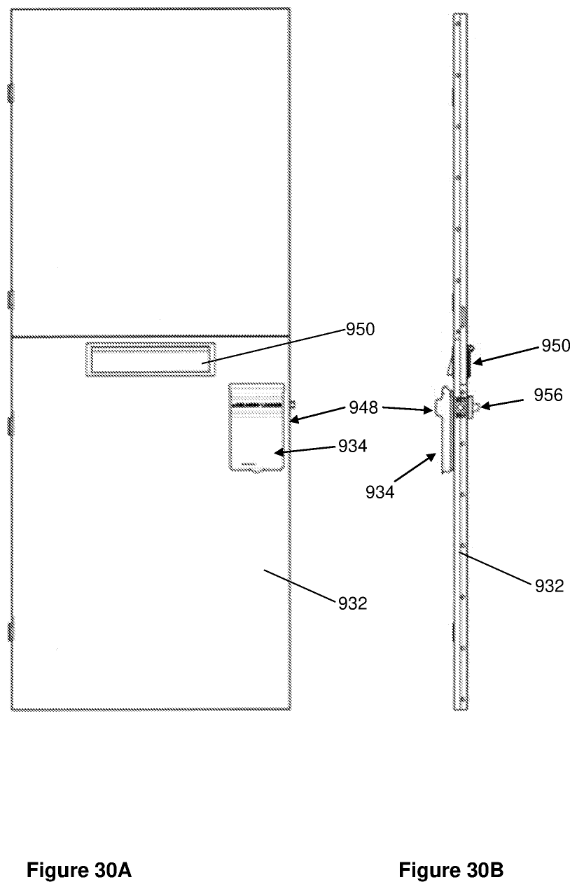

With reference to FIGS. 30A and 30B, there is shown a receiving enclosure door 932 according to an embodiment of the present invention. The door 932 includes a slot 950 for receiving small parcels and/or regular mail. The door 932 has a locking device 934 and a transparent cover 948 to cover the locking device 934. The locking device 934 includes an internal handle 956 to avoid people getting locked inside the receiving enclosure (not shown).

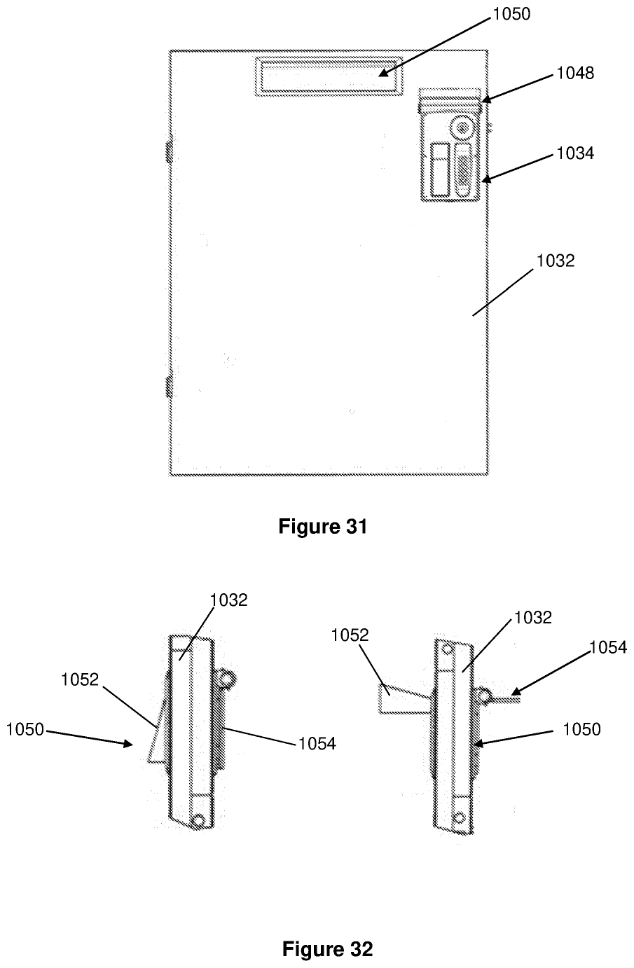

With reference to FIG. 31 there is shown a door 1032 of a receiving enclosure (not shown). The door 1032 has a slot 1050 for receiving small parcels and/or mail. The door 1032 also has a locking device 1034 and a transparent cover 1048 to cover the locking device 1034.

With reference to FIG. 32 there are shown side views of the slot 1050 of FIG. 31. The slot 1050 includes an outer flap 1052. The outer flap 1052 is hinged to the door 1032 at an upper edge thereof. The slot 1050 includes an inner flap 1054. The inner flap is hinged to the door 1032 at an upper edge thereof. The outer flap 1052 is shown in the closed position on the left side of FIG. 32. The inner flap 1054 includes a spring (not shown) that biases the flap 1054 in the closed position as shown on the left side of FIG. 32. The right side of FIG. 32 shows the outer flap 1052 and the inner flap 1054 in the open position.

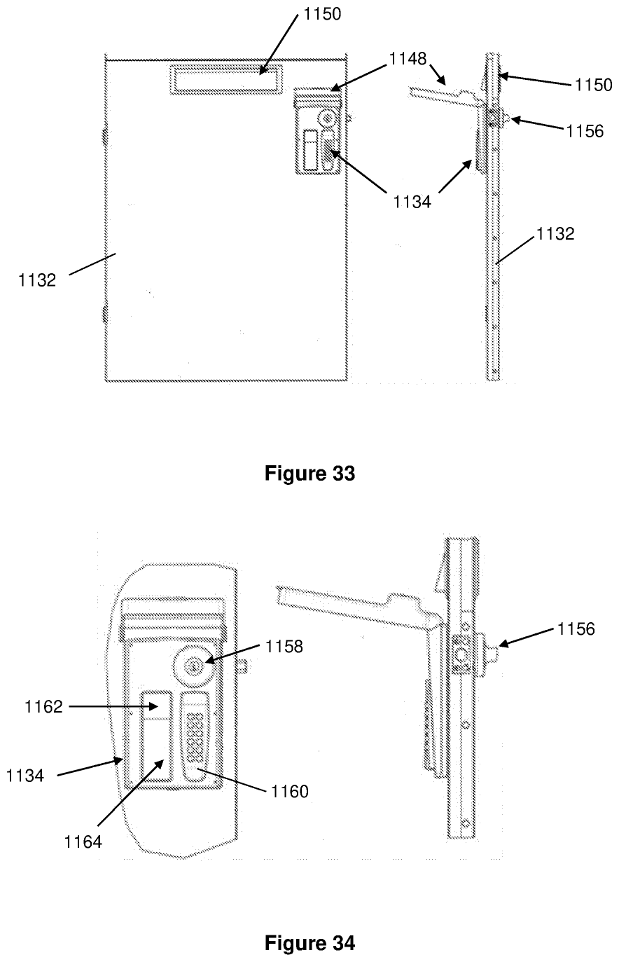

With reference to FIG. 33 there are shown views of a door 1132 of a receiving enclosure (not shown). The door 1132 has a slot 1150 for receiving small parcels and/or mail. The door 1132 also has a locking device 1134 and a transparent cover 1148 to cover the locking device 1134.

With reference to FIG. 34, there is shown a detailed front view and a detailed side view of the locking device 1134 of FIG. 33. The locking device 1134 includes a key lock 1158, which can be used in the event that there is a loss of power to the locking device 1134. The locking device also includes a keypad 1160 which can be used to enter a predetermined code to actuate the locking device 1134 (i.e. to unlock it). The locking device 1134 also includes a communications module 1164 so that the locking device 1134 can be actuated remotely by a mobile device (not shown) or by an rfid tag or the like. The locking device also includes a camera 1162. The camera is adapted to capture vision of the deliverer and the goods being delivered.

### Advantages

An advantage of the preferred embodiment of the receiving enclosure includes the ability to keep goods at a desired temperature. Another advantage of the preferred embodiment of the receiving enclosure includes the ability to keep delivered goods secure. A further advantage of the preferred embodiment of the receiving enclosure includes the ability to simplify the unlocking process for authorised persons.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A receiving enclosure for receiving goods, the receiving enclosure having
one or more doors movable between an open position and a closed position;
wherein at least one of the one or more doors includes a slot, and wherein a flap is located adjacent the slot on an external side of the at least one of the one or more doors, and wherein a flap is located adjacent the slot on an internal side of the at least one of the one or more doors; and
a locking device adapted to releasably secure the one or more doors in the closed position.

2. The receiving enclosure as claimed in claim 1, further comprising at least one temperature-controlled compartment.

3. The receiving enclosure as claimed in claim 1, wherein the locking device is an electronic locking device comprising a locking mechanism which is adapted to releasably secure the one or more doors in the closed position.

4. The receiving enclosure as claimed in claim 3, wherein the locking device can be remotely actuated, and wherein when actuated the locking device releases the one or more doors so that the one or more doors can move to the open position.

5. The receiving enclosure as claimed in claim 4, wherein the locking device can remotely communicate with a mobile device, and wherein the locking device is actuated when it receives a security code or authorisation code from the mobile device.

6. The receiving enclosure as claimed in claim 5, wherein the receiving enclosure comprises a communication module to communicate wirelessly with the mobile device.

7. The receiving enclosure as claimed in claim 1, wherein the locking device comprises a keypad to enable a code to be entered into the locking device to actuate the locking device.

8. The receiving enclosure as claimed in claim 1, further comprising cover adapted to cover the locking device or part thereof.

9. The receiving enclosure as claimed in claim 1, further comprising side panels and a rear panel, wherein the panels provide insulation.

10. The receiving enclosure as claimed in claim 1, further comprising at least one temperature-controlled compartment.

11. The receiving enclosure as claimed in claim 10, wherein at least one of the at least one temperature-controlled compartment is a warming and/or heating compartment, or a refrigeration and/or freezer compartment.

12. (canceled)

13. The receiving enclosure as claimed in claim 1, further comprising one or more sensors to detect when a delivery has been made, the one or more sensors comprising one or more of a weight sensor, a sensor to detect the opening or closing of the door or locking device, an infra-red sensor or the like.

14. The receiving enclosure as claimed in claim 13, wherein the receiving enclosure is able to communicate with a mobile device when a delivery has been made.

15. The receiving enclosure as claimed in claim 1, wherein the one or more doors is two doors.

16. A receiving enclosure for receiving goods, the receiving enclosure having
one or more doors movable between an open position and a closed position;
wherein at least one of the one or more doors comprises a slot, and wherein a flap is located adjacent the slot on an external side of the at least one of the one or more doors, and wherein a flap is located adjacent the slot on an internal side of the at least one of the one or more doors;
a locking device adapted to releasably secure the one or more doors in the closed position; and
at least one temperature-controlled compartment located within the enclosure.

17. A receiving enclosure for receiving goods, the receiving enclosure having
a cover movable between an open position and a closed position;
wherein the cover comprises a slot, and wherein a flap is located adjacent the slot on an external side of the cover, and wherein a flap is located adjacent the slot on an internal side of the cover;
a locking device adapted to releasably secure the cover in the closed position; and
at least one temperature-controlled compartment located within the enclosure.

18. A receiving enclosure for receiving goods, the receiving enclosure having
a cover movable between an open position and a closed position;
wherein the cover comprises a slot, and wherein a flap is located adjacent the slot on an external side of the cover, and wherein a flap is located adjacent the slot on an internal side of the cover;
a locking device adapted to releasably secure the cover in the closed position;
at least one warming and/or heating compartment located within the enclosure; and
at least one refrigerating and/or freezing compartment located within the enclosure.

19. A receiving enclosure for receiving goods, the receiving enclosure having
a door movable between an open position and a closed position;
a locking device adapted to releasably secure the door in the closed position;
wherein the locking device comprises an internal handle adapted to open the door from the inside of the receiving enclosure; and
at least one temperature-controlled compartment located within the enclosure.

20. The receiving enclosure as claimed in claim 1, further comprising an access door located on a different side of the receiving enclosure than the one or more doors, the cover or the door.
